(19) United States
(12) Patent Application Publication
(10) Pub. No.: US 2011/0082839 A1
(43) Pub. Date: Apr. 7, 2011

(54) GENERATING INTELLECTUAL PROPERTY INTELLIGENCE USING A PATENT SEARCH ENGINE

(75) Inventor: Jason David Resnick, Alexandria, VA (US)

(73) Assignee: FOUNDATIONIP, LLC, Minneapolis, MN (US)

(21) Appl. No.: 12/572,780

(22) Filed: Oct. 2, 2009

(51) Int. Cl. G06F 17/30

(52) U.S. Cl. 707/688; 707/E17.014; 707/E17.017

(57) ABSTRACT

A search platform that can generate intellectual property intelligence within an organization using a patent search engine. The patent search engine can monitor and log activity of users in connection with patent-related activities, such as searching, commenting on, and reviewing patent documents associated with a shared workspace of the organization. Based on this captured activity, the search engine can provide the organization with statistical information in patent-related activities occurring within the organization.

### FIELD OF THE DISCLOSURE

The disclosure of the present application relates to generating business intelligence in collaborative work environments, including a search platform that can generate business intelligence by evaluating patent document usage.

### BACKGROUND

Advances in technology can enable large organizations to support a collaborative work environment across multiple office locations. For example, in a large global organization having tens of thousands of employees, employees within particular divisions or groups may be scattered across the world, yet they can utilize collaborative enterprise software, for example, to work together on various projects.

Unfortunately, when an organization has a large number of employees and divisions, it can be difficult to manage intellectual property issues associated with the organization's workforce. For example, it can be difficult to appreciate which employees are involved with patent issues and the extent of any involvement. This can lead to a failure of the organization to fully appreciate the existence and/or extent of a patent issue that it may be facing.

### SUMMARY

A search platform is disclosed that can generate intellectual property intelligence within an organization using an intellectual property (e.g., patents and patent applications), or industrial property, search engine. The patent search engine can monitor and log activity of users in connection with patent-related activities, such as searching, commenting on, and reviewing patent documents associated with a shared workspace of the organization. Based on this captured activity, the search engine can provide the organization with statistical information in connection with patent-related activities occurring within the organization.

In one embodiment, a search engine can generate search engine usage data and/or workspace usage data by users associated with an organization, and provide statistical information based on such usage data to a user associated with the organization.

Search engine usage data can include data based on usage of the search engine, such as log data relating to the activity of users in connection with the search engine for example. Examples of logged search engine usage activity can include which patent documents were searched by what users of the search engine. Another example of search engine usage data can include annotations or comments, such as flags, rankings and/or textual comments for example, that can be associated with patent documents by users through the use of the search engine.

Workspace usage data can include usage of documents stored in a shared workspace, such as log data relating to the activity of users in connection with patent documents stored in the shared workspace for example. Examples of logged workspace usage activity can include what stored patent documents were viewed, and how long were the stored patent documents viewed and stored.

Statistical information pertaining to such usage can be organized and displayed by various categories, such as company, product area and technical area for example. In this manner, the search engine can provide a practical context to the generated usage data for the organization.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages:

FIG. 1 illustrates an example of a search platform architecture;

FIG. 2 illustrates an example of a process for searching a patent collection;

FIG. 3 illustrates an example of a process for generating statistics based on search engine usage data;

FIG. 4 illustrates an example of a process for generating statistics based on workspace usage data;

FIG. 5 illustrates an example of a process for generating statistics based on search engine and workspace usage data;

FIG. 6A illustrates an example of a request screen for usage information associated with patent documents;

FIG. 6B illustrates an example of additional criteria that can be collected from using from a client using the embodiments;

FIG. 7 illustrates an example of a result screen for usage information associated with patent documents;

FIG. 8 illustrates an example of a request screen for usage information associated with patent documents; and

FIG. 9 illustrates an example of a computing device.

### DETAILED DESCRIPTION

The present disclosure is directed to a search platform that can generate intellectual property intelligence within an organization using an intellectual property, or industrial property, search engine. The search engine can monitor and log activity of users in connection with patent-related activities, such as searching, commenting on, and reviewing patent-related documents and with technical literature that are associated with a shared workspace of the organization. Based on this captured activity, the search engine can provide the organization with statistical information in patent-related activities occurring within the organization.

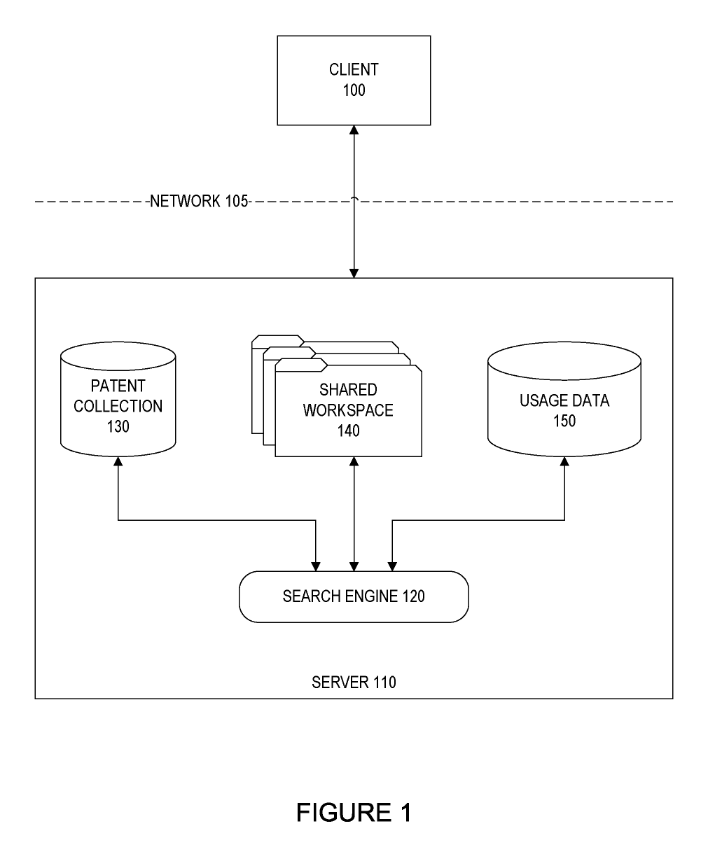

FIG. 1 illustrates an embodiment of a search platform architecture deployed within an organization. In the illustrated embodiment, a user operating client 100 can access server 110 across network 105. Server 110 can deploy search engine 120, which can be associated with patent collection 130, shared workspace 140 and usage data 150.

Patent collection 130 can include one or more databases storing patent-related documents, such as patents, patent applications/publications, and file histories, for example, associated with one or more national patent offices. Shared workspace 140 can include a storage area accessible to one or multiple users associated with the organization, and can define distinct workspaces associated with an organization entity, such as a division of the organization and/or one or more users associated with the organization. Work files associated with one or more projects and/or users associated with the organization can be stored in shared workspace 140. Work files can include documents or data, such as patent documents, patent disclosures or user's notes for example. Usage data 150 can include one or more databases storing data generated by search engine 120. Examples of usage data 150 can include, for example, data based on usage of search engine 120 (i.e., search engine usage data) and usage of documents stored in shared workspace 140 (i.e., workspace usage data).

Search engine usage data can include, for example, log data relating to the activity of users in connection with search engine 130. Examples of logged search engine usage activity can include what patent documents were searched by what users of search engine 120. Another example of search engine usage data can include annotations or comments, such as flags, rankings and/or textual comments for example, that can be associated with patent documents by users via search engine 120. Workspace usage data can include, for example, log data relating to the activity of users in connection with patent documents stored in shared workspace 140. Examples of logged workspace usage activity can include what stored patent documents were viewed and stored, and how long were the stored patent documents viewed and stored.

The manner in which search engine 120 can be deployed within an organization can be widely varied. For example, in the embodiment illustrated in FIG. 1, search engine 120 can be installed on one or more servers of the organization and operated by the organization. This can simplify configuration and access of search engine 120 to the organization's electronic resources (e.g., particular databases, workspaces, etc.) in accordance with teachings of the present disclosure. In another embodiment, search engine 120 can be hosted and operated by a third party, and be granted remote access to the organization's electronic resources in accordance with teachings of the present disclosure. Similarly, patent collection 130 can be installed and managed locally to the organization, or hosted and managed by a third party in accordance with teachings of the present disclosure.

The ways in which search engine 120 can search patent collection 130 can be widely varied. Based upon search terms provided to search engine 120, search engine 120 can generate a query to implement a search of patent documents. In one embodiment, for example, search engine 120 can employ a vector based search methodology to identify patent documents that have a similarity to the provided search terms.

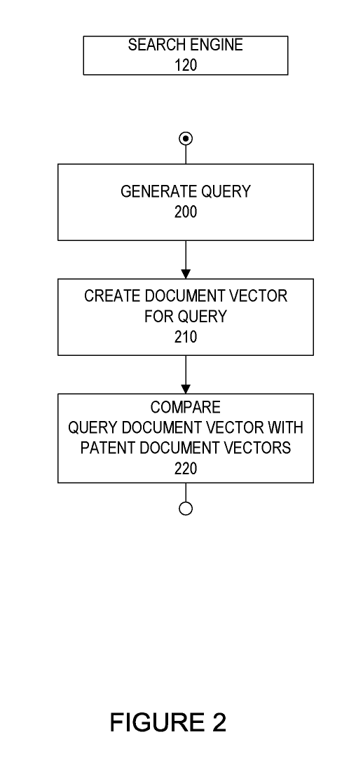

Search engine 120 can employ such a methodology with the generated query to identify patent documents that have a similarity to the provided search terms. As illustrated in the embodiment of FIG. 2, for example, search engine 120 can generate a query (block 200) based on the provided search terms. Search engine 120 can subsequently create (block 210) a document vector for the query. For example, the document vector can be a weighted list of words and phrases, such as:

[table, 1][chair, 0.5][plate, 0.2]

as a simplified example. Once the query document vector is created, search engine 120 can compare (block 220) the query document vector with retrieved document vectors that have been previously created for each of the patent documents to be searched in patent collection 130. The comparison can include, for example, multiplying the weights of any common terms among the query document vector and each retrieved document vector, and adding the results to obtain a similarity ranking. Taking another simplified example:

query document vector: [table, 1][chair, 0.5][plate, 0.2]

retrieved document vector: [cup, 1][saucer, 0.7][chair, 0.6][plate, 0.5]

similarity=0.5*0.6+0.2*0.5=0.4

If the similarity ranking exceeds a predefined threshold, search engine 120 can consider the patent document associated with the retrieved document vector to be a match. In other embodiments, rather than using a vector based search methodology, search engine 120 can utilize less dynamic search methodologies that do not involve the creation of document vectors for the patent documents.

In the vector-based search methodology described above, each patent document stored in patent collection 130 can be associated with one or more document vectors. For example, since patent documents such as patents and patent publications usually have a defined number of sections for meeting statutory filing requirements, a distinct document vector can be created for each section of a patent document, enabling search engine 120 to tailor a search on specific sections of the patent document. Further, the document vectors can be adjusted to remove non-relevant words or phrases among the provided search terms to yield a smaller and more concise document vector, which can improve efficiency of query processing due to time not spent by search engine 120 processing the removed strings.

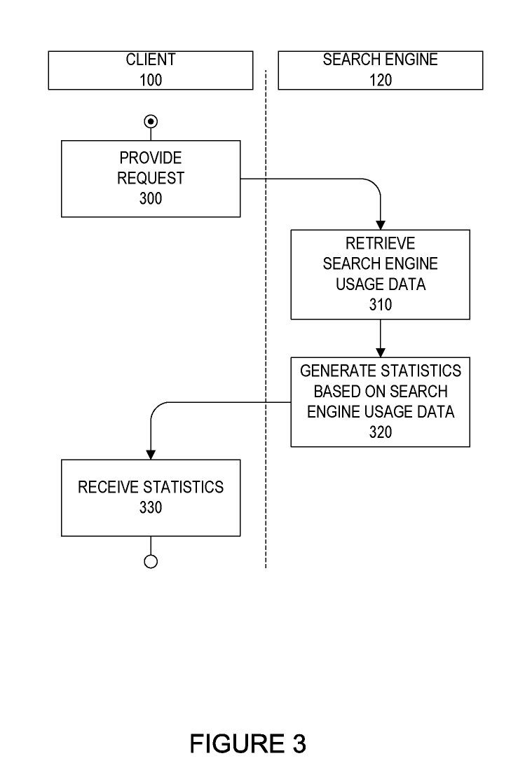

FIG. 3 illustrates an embodiment of a process for generating statistics based on search engine usage data. In the illustrated embodiment, client 100 can provide (block 300) a request to search engine 120 requesting statistical information in connection with patent-related activity within an organization based on search engine usage data criteria. In response to the request, search engine 120 can retrieve (block 310) search engine usage data from usage data 150 and generate (block 320) statistical information based on the retrieved search engine usage data. Client 100 can receive (block 330) the generated information provided by search engine 120 in response to the request.

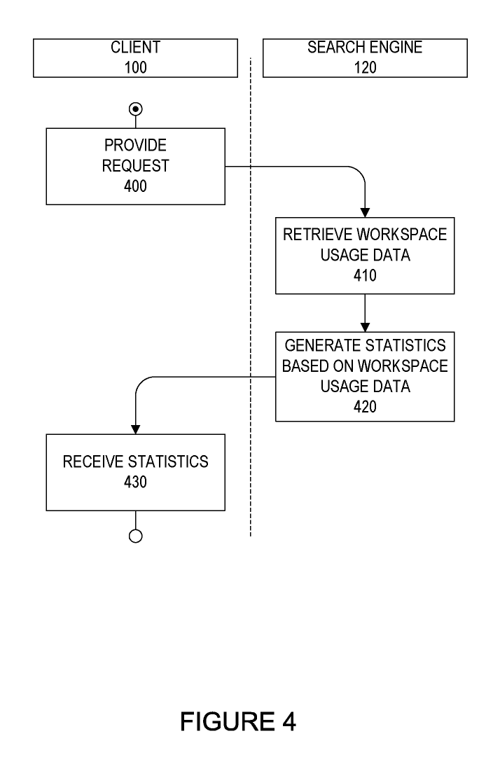

FIG. 4 illustrates an example of a process for generating statistics based on workspace usage data. In the illustrated embodiment, client 100 can provide (block 400) a request to search engine 120 requesting statistical information in connection with patent-related activity within an organization based on workspace usage data criteria. In response to the request, search engine 120 can retrieve (block 410) workspace usage data from usage data 150 and generate (block 420) statistical information based on the retrieved workspace usage data. Client 100 can receive (block 430) the generated information provided by search engine 120 in response to the request.

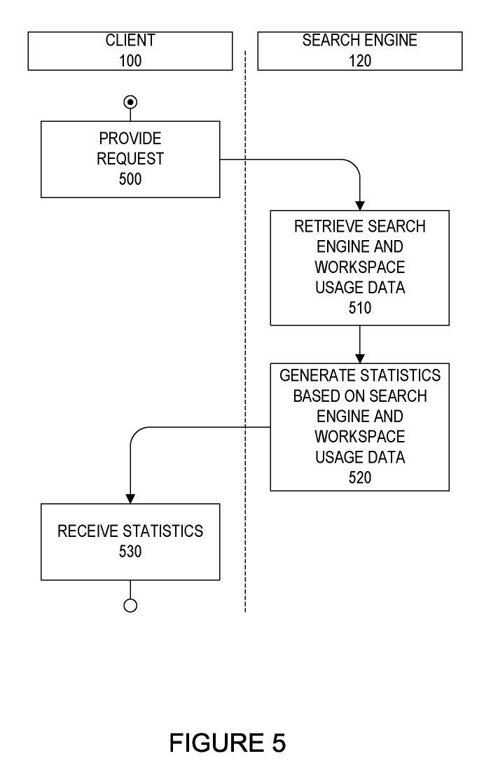

FIG. 5 illustrates an example of a process for generating statistics based on a combination of search engine and workspace usage data. In the illustrated embodiment, client 100 can provide (block 500) a request to search engine 120 requesting statistical information in connection with patent-related activity within an organization based on search engine and workspace usage data criteria. In response to the request, search engine 120 can retrieve (block 510) search engine and workspace usage data from usage data 150 and generate (block 520) statistical information based on the retrieved usage data. Client 100 can receive (block 530) the generated information provided by search engine 120 in response to the request.

In some embodiments, as reflected in the embodiments of FIGS. 5-7, the statistics can be generated after receiving a request for statistical information. However, the statistics can be generated at any suitable time, including before receiving a request for statistical information.

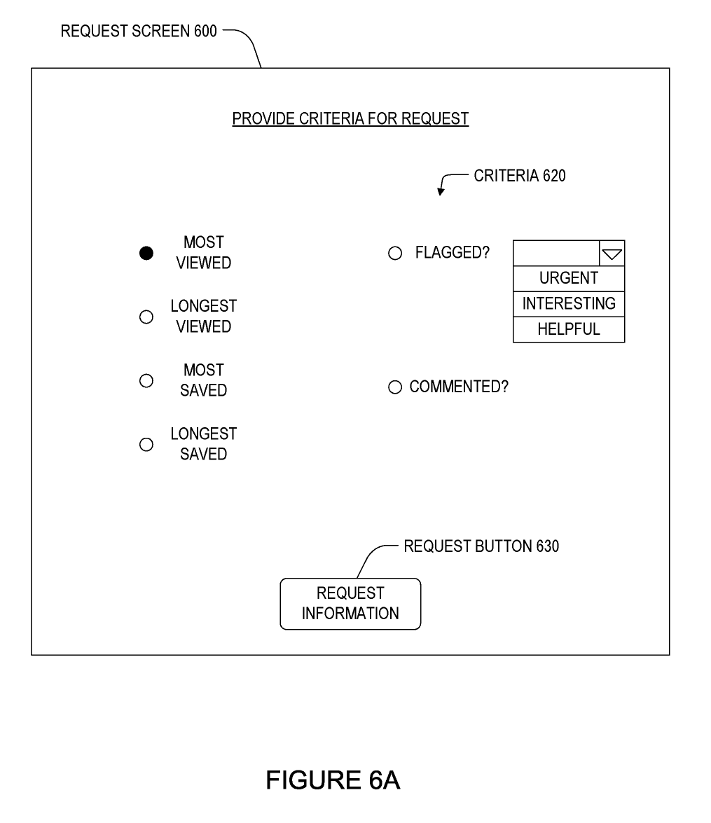

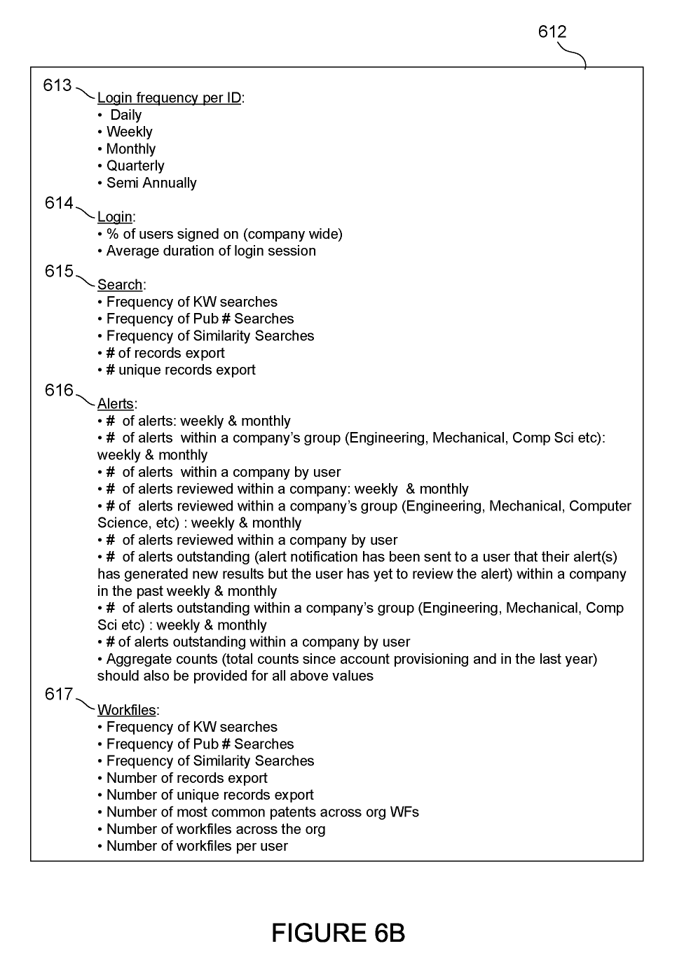

FIGS. 6A, 6B, 7, and 8 illustrate a computer-implemented workflow process through which search engine 120 can provide statistical information on patent-related activity to client 100. In the embodiment illustrated in FIG. 6A, request screen 600, which can be displayed on client 100 as part of the workflow process, can provide different criteria by which a user operating client 100 can formulate the request. For example, in accordance with the embodiment of FIG. 5, request screen 600 can specify criteria 610 relating to workspace usage data and criteria 620 relating to search engine usage data. Once client 100 selects the desired criteria, request button 630 can be selected by client 100 to initiate the processing of the request.

In the illustrated embodiment, criteria 610 can specify one or more options that can be selected by client 100 including patent documents in shared workspace 140 that have been viewed by the most users in an organization, those that have been viewed for the longest time by all users in the organization, those that have been saved in the most workspaces of shared workspace 140, and those that have been saved for the longest time. Criteria 620 can specify one or more options that can be selected by client 100 including patent documents in shared workspace 140 that have been flagged by users of the organization and those that have been commented on by the users via search engine 130. Different types of flags can be selectable in association with the flagged document criteria, including “urgent,” “interesting,” and “helpful.” It is noted that the illustrated criteria are for exemplary purposes only, and that other suitable criteria can be provided in accordance with search engine usage and workspace usage data that can be generated by search engine 120.

An list of alternative criteria to selectable criteria 610 is shown in the table 612 of FIG. 6B. Table 612 is an exemplary list and is not intended to limit the type of information and data that could be collected and analyzed from one or more clients using the embodiments. Criteria 612 is divided into categories according to the type of information and data that can be collected at certain stages of performing a search query or by performing certain tasks. Login criteria 613 is collected when a user via client 100 enters a user identification and/or password in order to gain access to search engine 120 via server 110. Frequency of logins of a client by an individual user, group, or company-wide as well as duration of use can be collected for analysis. Search criteria 614 related to search queries entered by a user is also collected. This includes frequency and types of search queries and search queries of specific databases (e.g., patents, technical journals, etc.), other subsets of data searched such as certain patent numbers or patent publication numbers, whether similarity or key word searches are performed, and the number of records and unique records exported via search engine 120 to shared workspace 140. Alert criteria 615 is collected from data relating to the steps of a client pre-defining a search query and then selecting an intermittent time to execute the pre-defined query. The query is executed automatically in the background whether or not the client is logged into the search engine 120 in a live session. Results of the alert query are saved into a workspace 140 for viewing an analysis at a time convenient to the client. Various data 614 may be grouped by type of alert such as an alert for the status of a patent and a query alert where search engine 120 has located new literature or intellectual property information as a result of the search. Work files criteria 616 include pertinent information relating to the use of and content of work files within shared workspace 140. Examples include the number of work files saved, the number of literature publications saved within a work file, work files that are shared with collaborators on research or a project, whether third-party searches have been requested from a work file, and the content of the saved literature and publications. Criteria may be gathered from individual users, groups, divisions, or an entire family of companies.

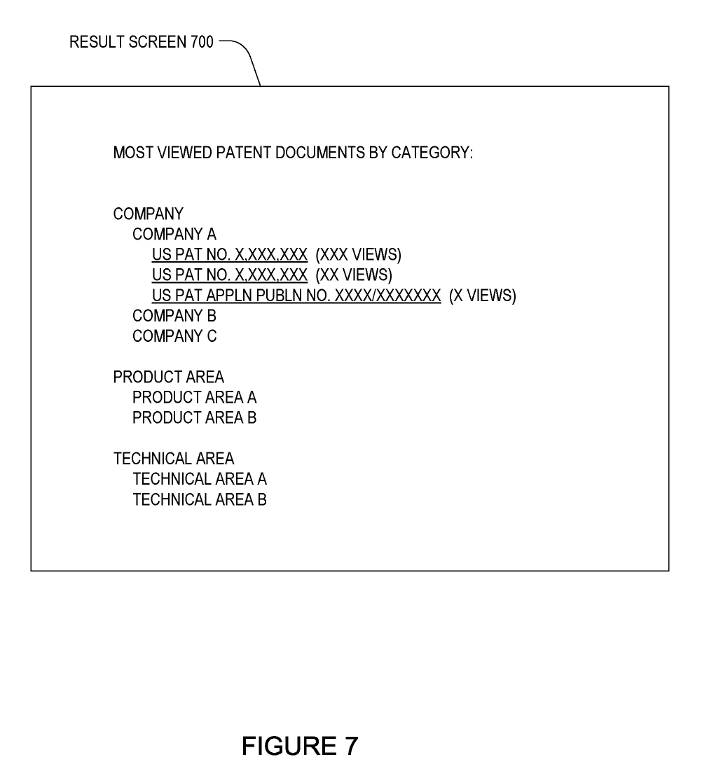

In the embodiment illustrated in FIG. 7, result screen 700, which can be displayed on client 100 as part of the workflow process, can provide statistical information in response to the request formulated in request screen 600. In the illustrated embodiment, for example, statistical information pertaining to the most viewed patent documents in shared workspace 140 can be organized and displayed by various categories, such as company, product area and technical area for example.

For instance, under the “COMPANY” category in result screen 700, search engine 120 can display a list of companies associated with the most viewed patents in shared workspace 140, ranked in the order of most viewed to least viewed, along with a list of the corresponding patent documents associated with each listed company and how many times each patent document has been viewed. Search engine 120 can rely on any suitable information, such as assignee information associated with the viewed patent documents for example, to determine which list of companies to display.

Under the “PRODUCT AREA” category in result screen 700, search engine 120 can display a list of product areas associated with the most viewed patents in shared workspace 140, ranked in the order of most viewed to least viewed, along with a list of the corresponding patent documents associated with each listed product area and how many times each patent document has been viewed. Search engine 120 can rely on any suitable information, such as International Patent Classification data or the U.S. Patent Classification data associated with the viewed patent documents for example, to determine which list of product areas to display. Another example would be to map the patent data to a commercial or industrial classification scheme and display those product areas. Some schemes include the North American Industry Classification System (NAICS), the Classification of Products by Activity (CPA) which in use by the European Union, and the Japan Standard Industrial Classification (JSIC).

Under the “TECHNICAL AREA” category in result screen 700, search engine 120 can display a list of technical areas associated with the most viewed patents in shared workspace 140, ranked in the order of most viewed to least viewed, along with a list of the corresponding patent documents associated with each listed technical area and how many times each patent document has been viewed. Search engine 120 can rely on any suitable information, such as International Patent Classification data and/or U.S. Patent Classification data associated with the viewed patent documents for example, to determine which list of technical areas to display. An example of a technical area can include “coating to reduce heat” for example.

Search engine 120 can organize and present the statistical information in any suitable manner. For example, the statistical information can be presented in graphical form in some embodiments. The statistical information can be presented through a variety of screens in some embodiments. Further, any suitable type of statistical information can be utilized. For example, in the embodiment illustrated in FIG. 7, search engine 120 can also determine and display the percentage breakdown per user of the most viewed patent documents in shared workspace 140 (e.g., X% of users viewed patent document A, Y% of users viewed patent document B, etc.).

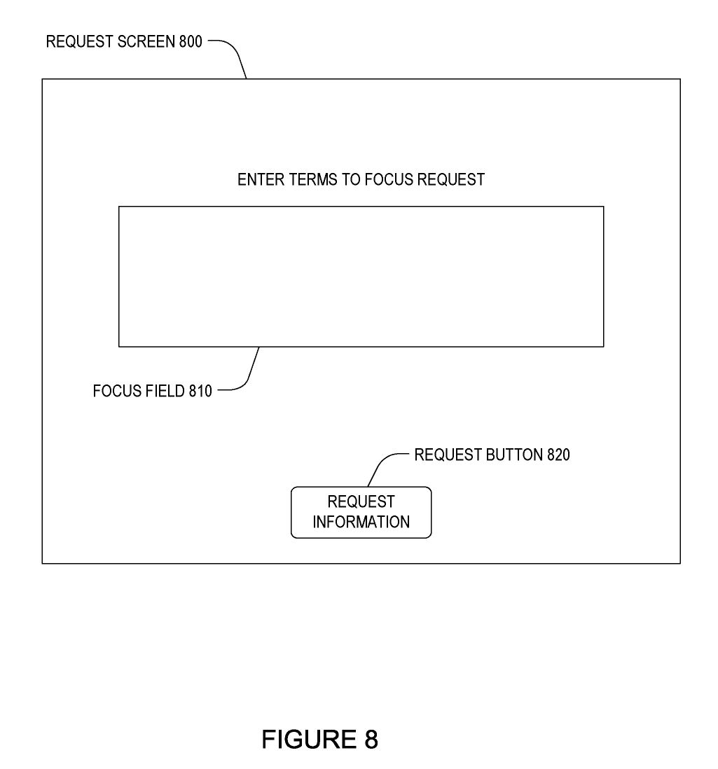

Additionally or alternatively, other screens, such as request screen 800 illustrated in FIG. 8, can be provided to client 100 to enable the user to narrow the field of patent documents on which search engine 120 generates statistics. In the embodiment illustrated in FIG. 8, focus field 810 can accept input constituting search terms provided by the user. After the search terms have been entered into focus field 810, the user can click request button 820, which can acts as an instruction to search engine 120 to generate statistics only on patent documents having similarity to the subject matter of the provided search terms. Search engine 120 can determine which patent documents satisfy the focus request in any suitable manner, such as by using a vector comparison operation as described above in connection with FIG. 2 for example. Search engine 120 can identify any similar patent documents associated with search engine and workspace usage data, and generate the requested statistical information based on the identified patent documents. It should be understood that the illustrated request screens can be presented to the user in any suitable order.

Further, statistical information gathered by search engine 120 can be used to make intelligent inferences by a user or company. For example, if one or more patents are searched, commented, upon, and saved by researchers beyond a frequency of access and time of review threshold across a group or business unit, then those patents could be further investigated by a legal specialist to determine if there are any liability issues such as infringement that could arise from the company's direction of product development. The targeted patents could also be investigated for a potential acquisition of the patent or their owner(s). The targeted patents could also be used by a patent specialist to interact with the research group to explain the technology of the specification and the scope of the claims. Further, a fuzzy logic system could review a few or all of the work files from across a company or research facility and, based upon the patent documents saved, the search data, the comments by researchers, and ongoing technical research being performed by users, make inferences as to how similar or how different the ongoing research is to what has been discovered within the patent documents of the work files. If there are no differences, then inferences could be made that the research is not discovering new technologies, or an alternative conclusion could be that not enough patents have been researched and that a professional prior art search is necessary. These inferences are possible by collecting the statistics and data of the user's search tasks and work space files.

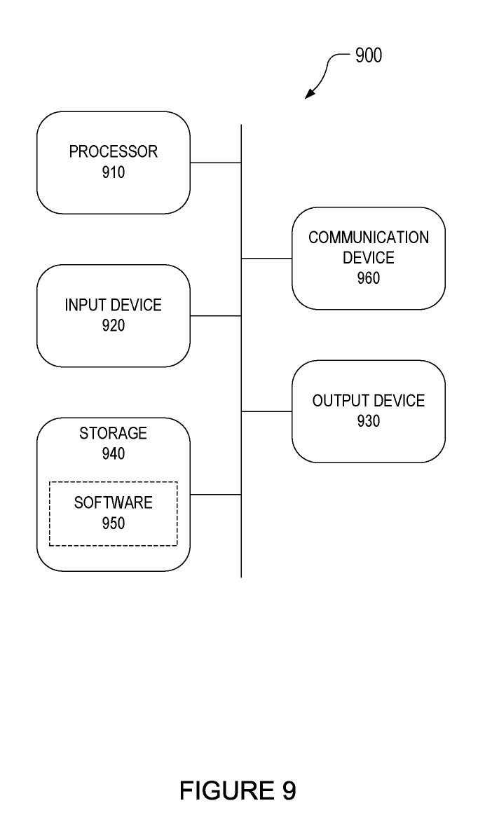

FIG. 9 shows a block diagram of an example of a computing device, which may generally correspond to client 100 and server 110. The form of computing device 900 may be widely varied. For example, computing device 900 can be a personal computer, workstation, server, handheld computing device, or any other suitable type of processor/microprocessor-based device or digital signal processing device, for example, comprising a memory space with address registers performing processing operations. Computing device 900 can include, for example, one or more components including processor 910, input device 920, output device 930, storage 940, and communication device 960. These components may be widely varied, and can be connected to each other in any suitable manner, such as via a physical bus, network line or wirelessly for example.

For example, input device 920 may include a keyboard, mouse, touch screen or monitor, voice-recognition device, or any other suitable device that provides input. Output device 930 may include, for example, a monitor, printer, disk drive, speakers, or any other suitable device that provides output.

Storage 940 may include volatile and/or nonvolatile data storage, such as one or more electrical, magnetic or optical memories such as a RAM, cache, hard drive, CD-ROM drive, tape drive or removable storage disk for example. Communication device 960 may include, for example, a network interface card, modem or any other suitable device capable of transmitting and receiving signals over a network.

Network 105 may include any suitable interconnected communication system, such as a local area network (LAN) or wide area network (WAN) for example. Network 105 may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Software 950 can be stored in storage 940 and executed by processor 910, and may include, for example, programming that embodies the functionality described in the various embodiments of the present disclosure. The programming may take any suitable form. For example, in one embodiment, programming embodying the patent collection search functionality of search engine 120 can be based on an enterprise search platform, such as the Fast Enterprise Search Platform by Microsoft Corp. for example, and programming embodying the specialized workflows and user interfaces of the various embodiments can be based on a collaborative content management platform and business intelligence tools, such as SharePoint and Business Intelligence provided by Microsoft Corp. for example.

Software 950 can also be stored and/or transported within any computer-readable storage medium for use by or in connection with an instruction execution system, apparatus, or device, such as computing device 900 for example, that can fetch instructions associated with the software from the instruction execution system, apparatus, or device and execute the instructions. In the context of this document, a computer-readable storage medium can be any medium, such as storage 940 for example, that can contain or store programming for use by or in connection with an instruction execution system, apparatus, or device.

Software 950 can also be propagated within any transport medium for use by or in connection with an instruction execution system, apparatus, or device, such as computing device 900 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated. Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

What is claimed is:

1. A system comprising:
a search engine executed by a microprocessor and configured to:
conduct a search of a database storing a patent collection;
generate usage data associated with usage of the search engine by users associated with an organization; and
provide statistical information based on the usage data to a user associated with the organization.

2. The system of claim 1, wherein the patent collection comprises patent documents, and the search engine is configured to conduct the search of the database by comparing a vector associated with a query to a vector associated with each of the patent documents.

3. The system of claim 1, wherein the usage data comprises an annotation associated with one of the patent documents retrieved by the search engine.

4. The system of claim 3, wherein the annotation comprises a textual comment.

5. The system of claim 3, wherein the annotation comprises a ranking.

6. The system of claim 3, wherein the annotation comprises a flag.

7. A method comprising:
receiving, by a search engine executed by a microprocessor, a request for statistical information associated with usage of the search engine by users associated with an organization;
generating, by the search engine, statistical information based on stored usage data generated by the search engine; and
providing, by the search engine, the statistical information to a user associated with the organization in response to the request.

8. The method of claim 7, wherein the search engine is configured to conduct a search of patent documents by comparing a vector associated with a query to a vector associated with each of the patent documents.

9. The method of claim 8, wherein the stored usage data comprises annotations associated with a patent document retrieved by the search engine.

10. A system comprising:
a search engine executed by a microprocessor and associated with a database storing a patent collection and a data store comprising a shared workspace accessible to users in an organization, the search engine configured to:
conduct a search of the database,
generate usage data associated with usage of patent documents stored in the shared workspace, and
provide statistical information based on the usage data to a user associated with the organization.

11. The system of claim 10, wherein the patent collection comprises patent documents, and the search engine is configured to conduct the search of the database by comparing a vector associated with a query to a vector associated with each of the patent documents.

12. The system of claim 10, wherein the search engine is configured to provide to a user associated with the organization a patent document from the patent collection as a result of the search, and
store the provided patent document to a location in the shared workspace associated with the user.

13. The system of claim 10, wherein the statistical information comprises which of the patent documents are most commonly stored in the shared workspace.

14. The system of claim 10, wherein the statistical information comprises how long the patent documents have been viewed.

15. The system of claim 10, wherein the statistical information comprises how long the patent documents have been stored in the shared workspace.

16. A method comprising:
receiving by a search engine executed by a microprocessor a request for statistical information associated with usage of patent documents stored in a shared workspace associated with an organization;
generating by the search engine statistical information based on stored usage data generated by the search engine; and
providing by the search engine the statistical information to a user associated with the organization in response to the request.

17. The method of claim 16, wherein the search engine is configured to conduct a search of patent documents by comparing a vector associated with a query to a vector associated with each patent document.

18. The method of claim 16, wherein the statistical information comprises which of the patent documents are most commonly stored in the shared workspace.

19. The method of claim 16, wherein the statistical information comprises how long the patent documents have been viewed.

20. The method of claim 16, wherein the statistical information comprises how long the patent documents have been stored in the shared workspace.

21. A computer-readable storage medium storing instructions executable by a computer to:
conduct a search of a database storing a patent collection;
generate usage data associated with usage of the search engine by users associated with an organization and with usage of patent documents stored in a data store comprising a shared workspace accessible to users in the organization; and
provide statistical information based on the usage data to a user associated with the organization.

22. A system comprising:
means for conducting a search of a database storing a patent collection;
means for generating usage data associated with usage of the search engine by users associated with an organization and with usage of patent documents stored in a data store comprising a shared workspace accessible to users in the organization; and
means for providing statistical information based on the usage data to a user associated with the organization.

23. A transport medium encoding instructions executable by a computer to:
conduct a search of a database storing a patent collection;
generate usage data associated with usage of the search engine by users associated with an organization and with usage of patent documents stored in a data store comprising a shared workspace accessible to users in the organization; and
provide statistical information based on the usage data to a user associated with the organization.
